(19) United States
(12) Patent Application Publication
(10) Pub. No.: US 2025/0142627 A1
(43) Pub. Date: May 1, 2025

(54) ACCESS RESOURCE SELECTION FOR SMALL DATA TRANSMISSION

(71) Applicant: Nokia Technologies Oy, Espoo (FI)

(72) Inventors: Jussi-Pekka KOSKINEN, Oulu (FI); Samuli Heikki TURTINEN, Oulu (FI); Chunli WU, Beijing (CN)

(21) Appl. No.: 18/835,707

(22) PCT Filed: Feb. 18, 2022
(86) PCT No.: PCT/CN2022/076745

§ 371 Date: Aug. 2, 2024

(51) Int. Cl. H04W 74/0833

(52) U.S. Cl. CPC H04W 74/0833

(57) ABSTRACT

Embodiments of the present disclosure relate to devices, methods, apparatuses, and computer readable storage media of access resource selection for Small Data Transmission (SDT). The method comprises determining one or more resources used for a mobile terminated type SDT procedure; and performing the mobile terminated type SDT procedure to a second device based on the determined one or more resources. In this way, separate resources can be configured for mobile originated SDT (MO-SDT) and mobile terminated SDT (MT-SDT). It is beneficial considering the MO-SDT and MT-SDT might have different assumption/thresholds of UL data available for transmission and Reference Signal Received Power (RSRP) threshold, hence impact the network response or further scheduling.

### FIELD

Embodiments of the present disclosure generally relate to the field of telecommunication and in particular to devices, methods, apparatuses, and computer readable storage media of access resource selection for Small Data Transmission (SDT).

### BACKGROUND

In release 17, the mobile originated SDT (MO-SDT) has been specified to allow small packet transmission for Uplink (UL) oriented packets. For the Downlink (DL), mobile terminated SDT (MT-SDT) (i.e., DL-triggered small data) may allow similar benefits. For example, the signalling overhead and UE power consumption can be reduced by not transitioning to the Radio Resource control connected mode (RRC_CONNECTED) and the latency, for example, in a positioning procedure, may also be reduced by allowing fast transmission of (small and infrequent) packets.

### SUMMARY

In general, example embodiments of the present disclosure provide a solution of access resource selection for SDT.

In a first aspect, there is provided a first device. The first device comprises at least one processor; and at least one memory including computer program codes; the at least one memory and the computer program codes are configured to, with the at least one processor, cause the first device at least to determine one or more resources used for a mobile terminated type SDT procedure; and perform the mobile terminated type SDT procedure to a second device based on the determined one or more resources.

In a second aspect, there is provided a method. The method comprises determining, at a first device, one or more resources used for a mobile terminated type SDT procedure; and performing the mobile terminated type SDT procedure to a second device using the determined one or more resources.

In a third aspect, there is provide an apparatus comprising means for determining one or more resources used for a mobile terminated type SDT procedure; and means for performing the mobile terminated type SDT procedure to a second device based on the determined one or more resources.

In a fourth aspect, there is provided a computer readable medium having a computer program stored thereon which, when executed by at least one processor of a device, causes the device to carry out the method according to the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of access resource selection for SDT according to some example embodiments of the present disclosure;

FIG. 3 shows a flowchart of an example method of access resource selection for SDT according to some example embodiments of the present disclosure;

FIG. 4 shows a simplified block diagram of a device that is suitable for implementing example embodiments of the present disclosure; and

FIG. 5 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT), Non-terrestrial Network (NTN) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

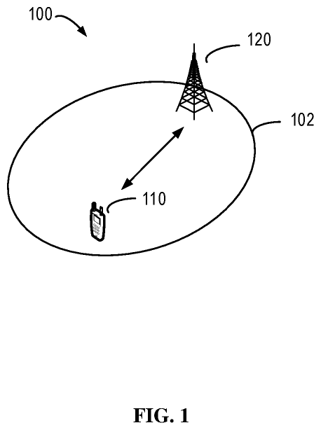

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120 (hereinafter may also be referred to as a gNB 120 or a second device 120). The terminal device 110 and the network device 120 can communicate with each other in the coverage of the cell 101 and the terminal device 110.

It is to be understood that the number of network devices and terminal devices shown in FIG. 1 is given for the purpose of illustration without suggesting any limitations. The communication network 100 may include any suitable number of network devices and terminal devices.

As described above, the MO-SDT for the UL transmission and the MT-SDT for the DL transmission are proposed for signalling overhead and latency reduction.

Currently, mobile originated early data transmission (MO-EDT), mobile terminated early data transmission (MT-EDT) and Transmission using Preconfigured Uplink Resource (PUR) has been specified for LTE. For MT-EDT, the UE may perform SDT for single DL data transmission upon reception of paging message with MT-SDT indication without further criteria checking at UE side in case no further UL transmission is assumed.

Specifically, it has been specified that in response to the paging message including MT-EDT indication, the UE may trigger the MO-EDT procedure for Control Plane (CP) Cognitive Internet of Things (CIoT) Evolved Packet System (EPS) optimisation or for User Plane (UP) CIoT EPS optimisation if the upper layers request the establishment or resumption of the RRC Connection for Mobile Terminated Call.

As known, the SDT procedure is a procedure allowing data transmission while remaining in RRC inactive mode (RRC_INACTIVE). In release 17, MO-SDT may be enabled on a radio bearer basis and initiated by the UE only if less than a configured amount of UL data awaits transmission across all radio bearers for which SDT is enabled, the measured RSRP in the cell is above a configured threshold, and a valid resource for SDT transmission is available.

It is to be expected that the MT-SDT would also be introduced. Therefore, resource selection may also need to be specified for MT-SDT. Reuse of the MO-SDT resource may not be optimal for MT-SDT because the UE may not be aware how much and what kind of traffic is going to be transmitted in DL and the UL data volume for MT-SDT may be different from MO-SDT. Therefore, the resource selection for the MT-SDT may need to be further considered.

The present disclosure provides solutions of access resource selection for SDT. In this solution, the UE may determine one or more resources used for a mobile terminated type SDT procedure and perform the mobile terminated type SDT procedure to a second device based on the determined one or more resources. In this way, separate resources can be configured for MO-SDT and MT-SDT. It is beneficial considering the MO-SDT and MT-SDT might have different assumption/thresholds of UL data available for transmission and Reference Signal Received Power (RSRP) threshold, hence impact the network response or further scheduling.

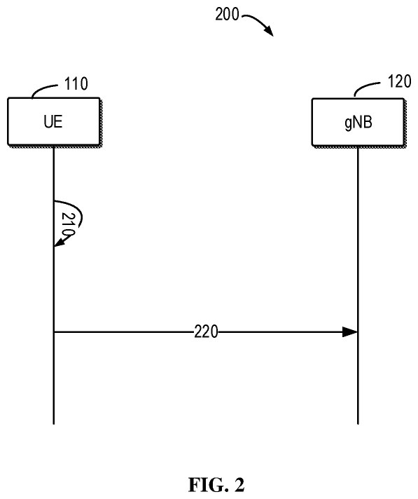

Principle and implementations of the present disclosure will be described in detail below with reference to FIG. 2, which shows a signaling chart illustrating a process 200 of access resource selection for SDT according to some example embodiments of the present disclosure. For the purpose of discussion, the process 200 will be described with reference to FIG. 1. The process 200 may involve the UE 110 and the gNB 120.

As shown in FIG. 2, when a transmission is to be performed from the UE 110 in a MT-SDT procedure, the UE 110 may determine 210 one or more resources used for the MT-SDT procedure.

In some example embodiments, a set of resource allocated for normal non-SDT random access (RA) process can be used for the MT-SDT procedure.

As an option, if the UE 110 determines that no uplink data other than a common control channel (CCCH) message is to be transmitted in a random access procedure message, such as Message 3 (MSG 3) or Message A (MSG A), the UE 110 may use the set of resource allocated for normal non-SDT random access process for the MT-SDT procedure.

As another option, the UE 110 may use the set of resource allocated for normal non-SDT random access process for the MT-SDT procedure regardless of whether there is a UL data transmission in a random access procedure message. Because the network may be aware of the initiation of a SDT procedure upon reception of the UE's ID in MSG 3 or MSG A, and therefore the network may know that the UE is not to be transited to the RRC connected mode.

It is also possible that if the UE 110 determines that no uplink data is to be transmitted on data radio bearer (DRB) configured for SDT, the UE 110 may use the set of resource allocated for normal non-SDT random access process for the MT-SDT procedure.

In some example embodiments, a set of resources used for a SDT RA procedure can be used for the MT-SDT procedure.

Specifically, if the UE 110 determines that there is UL data transmission for the MT-SDT (or with other words there is no UL data pending for transmission on RB configured for SDT) in a random access procedure message, such as MSG 3 or MSG A, or regardless of whether there is UL data transmission for the MT-SDT in a random access procedure message, the UE 110 may use the set of resource allocated for the SDT RA procedure for the MT-SDT procedure.

Alternatively, the UE 110 may receive an indication that which resource(s) to be used for the MT-SDT procedure, for example, from the gNB 120. The resource(s) to be used for the MT-SDT procedure can be configured by the gNB 120 and indicated to the UE 110 via a paging message or a broadcasted message.

Furthermore, in some example embodiments, it is also possible that one or more MT-SDT specific RACH resources can be configured. If the UE 110 determines that at least one criteria for initiating the MT-SDT procedure is satisfied while the at least one criteria for initiating the MO-SDT procedure fails to be satisfied, the UE 110 may use the one or more MT-SDT specific RACH resources for the MT-SDT procedure.

If the at least one criteria for initiating the MO-SDT procedure is satisfied as well, the UE 110 may also use one or more MO-SDT RACH resources for the MT-SDT procedure. It is also possible that the UE 110 may be forced to use the one or more MT-SDT specific RACH resources always upon the initiation of the MT-SDT procedure, even if the at least one criteria for initiating the MO-SDT procedure is satisfied.

As another option, the one or more MT-SDT specific RACH resources may also be used for the MT-SDT procedure in a case where the UE 110 has no UL data or has a UL data with a data volume less than a configured volume threshold.

In some example embodiments, the UL grant (either one shot or Configured Grant (CG) type of periodic ones) may be provided via the paging message for the UE 110 to perform the UL transmission in the MT-SDT procedure. Optionally, indicating UL grant via the paging message may be limited only to the cell where the UE 110 was sent to in an RRC inactive (RRC_INACTIVE) mode. Alternatively, it may also be left to the implementation at the network side.

In some example embodiments, the UE 110 may indicate by a logical channel identifier (LCID) at Media Access Control (MAC) layer that the procedure is initiated for MT-SDT even though non-SDT resume RRC message is used and/or non-SDT RACH resources are used. For example, the LCID may be referred to as the LCID used to identify CCCH Service Date Unit (SDU).

Specifically, for example, if the UE 110 determines that no uplink data is to be transmitted or uplink data to be transmitted having a data volume less than a threshold volume, the UE 110 may indicate by a LCID that the procedure is initiated for MT-SDT, in a case where non-SDT resume RRC message is used and/or non-SDT RACH resources are used.

Referring back to FIG. 2, when the one or more resources used for the MT-SDT procedure are determined, the UE 110 may perform 220 the MT-SDT procedure to a second device by using the determined one or more resources. For example, the MT-SDT procedure can be performed after paging with MT-SDT indication.

In this way, separate resources can be configured for MO-SDT and MT-SDT. It is beneficial considering the MO-SDT and MT-SDT might have different assumption/thresholds of UL data available for transmission and Reference Signal Received Power (RSRP) threshold, hence impact the network response or further scheduling.

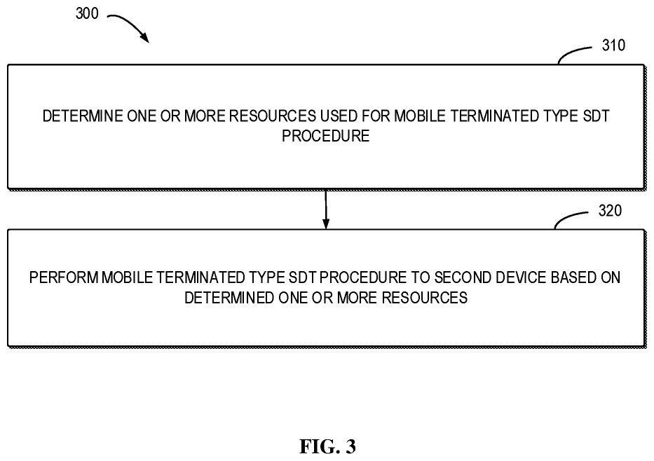

FIG. 3 shows a flowchart of an example method 300 of access resource selection for SDT according to some example embodiments of the present disclosure. The method 300 can be implemented at the first device 110 as shown in FIG. 1. For the purpose of discussion, the method 300 will be described with reference to FIG. 1.

At 310, the first device determines one or more resources used for a mobile terminated type Small Data Transmission, SDT, procedure.

In some example embodiments, the first device may determine the one or more resources based on a set of resources allocated for a non-SDT random access procedure.

In some example embodiments, if the first device determines that no uplink data other than a common control channel message is to be transmitted in a random access procedure message, the first device may determine the one or more resources based on a set of resources allocated for a non-SDT random access procedure.

In some example embodiments, if the first device determines that no uplink data is to be transmitted on DRB configured for SDT, the first device may determine the one or more resources based on a set of resources allocated for a non-SDT random access procedure.

In some example embodiments, the first device may determine the one or more resources based on a set of resources allocated for a SDT random access procedure.

In some example embodiments, if the first device determines that uplink data associated with the mobile terminated type SDT procedure is to be transmitted in a random access procedure message, the first device may determine the one or more resources based on a set of resources allocated for a SDT random access procedure.

In some example embodiments, the first device may receive, from the second device, an indication of the one or more resources used for the mobile terminated type SDT procedure; and determine the one or more resources based on the indication.

In some example embodiments, the indication is received via a paging message or a dedicate signalling.

In some example embodiments, the first device may obtain a set of random access resources specified for the mobile terminated type SDT procedure. If the first device determines that at least one criteria for initiating the mobile terminated type SDT procedure is satisfied while at least one criteria for initiating a mobile originated type SDT procedure fails to be satisfied, the first device may determine the one or more resources based on the set of random access resources specified for the mobile terminated type SDT procedure.

In some example embodiments, the first device may obtain a set of random access resources specified for the mobile terminated type SDT procedure. If the first device determines that no uplink data is to be transmitted or uplink data to be transmitted having a data volume less than a threshold volume, the first device may determine the one or more resources based on the set of random access resources specified for the mobile terminated type SDT procedure.

In some example embodiments, the first device may obtain a set of random access resources specified for the mobile terminated type SDT procedure. If the first device determines that at least one criteria for initiating the mobile terminated type SDT procedure is satisfied while at least one criteria for initiating a mobile originated type SDT procedure is satisfied, the first device may determine based on at least one of: the set of random access resources specified for the mobile terminated type SDT procedure, or a set of random access resources specified for the mobile originated type SDT procedure.

In some example embodiments, if the first device determines that an indication that the set of random access resources specified for the mobile terminated type SDT procedure is to be used upon an initiation of the mobile terminated type SDT procedure, the first device may determine the one or more resources based on the set of random access resources specified for the mobile terminated type SDT procedure.

In some example embodiments, the first device may determine the one or more resources based on an uplink grant configured by the second device.

At 320, the first device performs the mobile terminated type SDT procedure to a second device based on the determined one or more resources.

In some example embodiments, the first device may indicate that the mobile terminated type SDT procedure is initiated by an logical channel identifier when a non-SDT radio resource control message is used or a set of resources allocated for a non-SDT random access procedure are used.

In some example embodiments, if the first device determines that no uplink data is to be transmitted or uplink data to be transmitted having a data volume less than a threshold volume, the first device may indicate that the mobile terminated type SDT procedure is initiated by an logical channel identifier when a non-SDT radio resource control message is used or a set of resources allocated for a non-SDT random access procedure are used.

In some example embodiments, the first device comprises a terminal device and the second device comprises a network device.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for determining one or more resources used for a mobile terminated type SDT procedure; and means for performing the mobile terminated type SDT procedure to a second device based on the determined one or more resources.

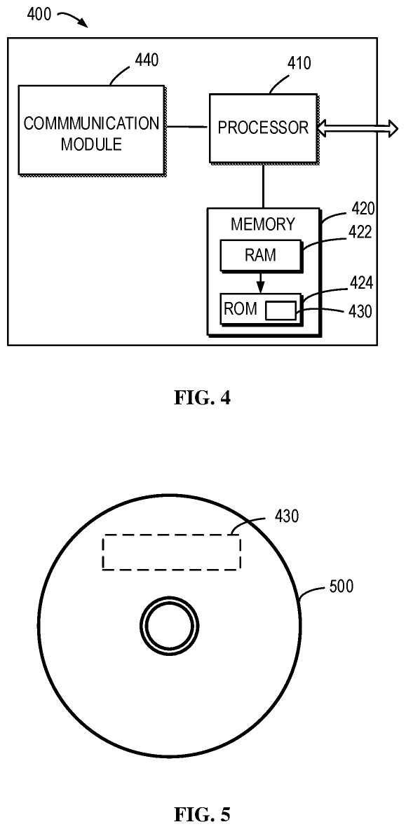

FIG. 4 is a simplified block diagram of a device 400 that is suitable for implementing embodiments of the present disclosure. The device 400 may be provided to implement the communication device, for example the UE 110 as shown in FIG. 1. As shown, the device 400 includes one or more processors 410, one or more memories 440 coupled to the processor 410, and communication modules 440 coupled to the processor 410.

The communication module 440 is for bidirectional communications. The communication module 440 has one or more communication interfaces to facilitate communication with one or more other modules or devices. The communication interfaces may represent any interface that is necessary for communication with other network elements. In some example embodiments, the communication module 440 may include at least one antenna.

The processor 410 may be of any type suitable to the local technical network and may include one or more of the following: general purpose computers, special purpose computers, microprocessors, digital reference signal processors (DSPs) and processors based on multicore processor architecture, as non-limiting examples. The device 400 may have multiple processors, such as an application specific integrated circuit chip that is slaved in time to a clock which synchronizes the main processor.

The memory 420 may include one or more non-volatile memories and one or more volatile memories. Examples of the non-volatile memories include, but are not limited to, a Read Only Memory (ROM) 424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 422 and other volatile memories that will not last in the power-down duration.

A computer program 430 includes computer executable instructions that are executed by the associated processor 410. The program 430 may be stored in the ROM 420. The processor 410 may perform any suitable actions and processing by loading the program 430 into the RAM 420.

The embodiments of the present disclosure may be implemented by means of the program 430 so that the device 400 may perform any process of the disclosure as discussed with reference to FIGS. 2 to 3. The embodiments of the present disclosure may also be implemented by hardware or by a combination of software and hardware.

In some embodiments, the program 430 may be tangibly contained in a computer readable medium which may be included in the device 400 (such as in the memory 420) or other storage devices that are accessible by the device 400. The device 400 may load the program 430 from the computer readable medium to the RAM 422 for execution. The computer readable medium may include any types of tangible non-volatile storage, such as ROM, EPROM, a flash memory, a hard disk, CD, DVD, and the like. FIG. 5 shows an example of the computer readable medium 500 in form of CD or DVD. The computer readable medium has the program 430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 as described above with reference to FIG. 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a reference signal, computer readable medium, and the like.

The computer readable medium may be a computer readable reference signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program codes;
the at least one memory and the computer program codes are configured to, with the at least one processor, cause the first device at least to:
determine one or more resources used for a mobile terminated type Small Data Transmission, SDT, procedure; and
perform the mobile terminated type SDT procedure to a second device based on the determined one or more resources.

2. The first device of claim 1, wherein the first device is caused to determine one or more resources
based on a set of resources allocated for a non-SDT random access procedure.

3. The first device of claim 1, wherein the first device is caused to determine one or more resources based on a set of resources allocated for a non-SDT random access procedure,
in accordance with a determination that no uplink data other than a common control channel message is to be transmitted in a random access procedure message, or in accordance with a determination that no uplink data is to be transmitted on data radio bearer, DRB, configured for SDT or in accordance with a determination that uplink data associated with the mobile terminated type SDT procedure is to be transmitted in a random access procedure message.

4-6. (canceled)

7. The first device of claim 1, wherein the first device is caused to determine one or more resources by:
receiving, from the second device, an indication of the one or more resources used for the mobile terminated type SDT procedure; and
determining the one or more resources based on the indication, wherein the indication is received via a paging message or a dedicate signalling.

8. (canceled)

9. The first device of claim 1, wherein the first device is caused to determine one or more resources by:
obtaining a set of random access resources specified for the mobile terminated type SDT procedure; and
in accordance with a determination that at least one criteria for initiating the mobile terminated type SDT procedure is satisfied while at least one criteria for initiating a mobile originated type SDT procedure fails to be satisfied, determining the one or more resources based on the set of random access resources specified for the mobile terminated type SDT procedure.

10. The first device of claim 1, wherein the first device is caused to determine one or more resources by:
obtaining a set of random access resources specified for the mobile terminated type SDT procedure; and
in accordance with a determination that no uplink data is to be transmitted or uplink data to be transmitted having a data volume less than a threshold volume, determining the one or more resources based on the set of random access resources specified for the mobile terminated type SDT procedure.

11. The first device of claim 1, wherein the first device is caused to determine one or more resources by:
obtaining a set of random access resources specified for the mobile terminated type SDT procedure; and
in accordance with a determination that at least one criteria for initiating the mobile terminated type SDT procedure is satisfied while at least one criteria for initiating a mobile originated type SDT procedure is satisfied, determining the one or more resources based on at least one of:
the set of random access resources specified for the mobile terminated type SDT procedure, or
a set of random access resources specified for the mobile originated type SDT procedure.

12. The first device of claim 10, wherein the first device is caused to determine one or more resources by
in accordance with a determination that an indication that the set of random access resources specified for the mobile terminated type SDT procedure is to be used upon an initiation of the mobile terminated type SDT procedure, based on the set of random access resources specified for the mobile terminated type SDT procedure.

13. The first device of claim 1, wherein the first device is caused to determine one or more resources
based on an uplink grant configured by the second device.

14. The first device of claim 1, wherein the first device is further caused to:
indicate that the mobile terminated type SDT procedure is initiated by an logical channel identifier when a non-SDT radio resource control message is used or a set of resources allocated for a non-SDT random access procedure are used.

15. The first device of claim 1, wherein the first device is further caused to:
in accordance with a determination that no uplink data is to be transmitted or uplink data to be transmitted having a data volume less than a threshold volume, indicate that the mobile terminated type SDT procedure is initiated by an logical channel identifier when a non-SDT radio resource control message is used or a set of resources allocated for a non-SDT random access procedure are used.

16. (canceled)

17. A method comprising:
determining, at a first device, one or more resources used for a mobile terminated type Small Data Transmission, SDT, procedure; and
performing the mobile terminated type SDT procedure to a second device based on the determined one or more resources.

18. The method of claim 17, wherein determining the one or more resources comprises:
determining the one or more resources based on a set of resources allocated for a non-SDT random access procedure.

19. The method of claim 17, wherein determining the one or more resources comprises:
in accordance with a determination that no uplink data other than a common control channel message is to be transmitted in a random access procedure message, determining the one or more resources based on a set of resources allocated for a non-SDT random access procedure.

20. The method of claim 17, wherein determining the one or more resources comprises:
in accordance with a determination that no uplink data is to be transmitted on data radio bearer, DRB, configured for SDT, determining the one or more resources based on a set of resources allocated for a non-SDT random access procedure.

21. The method of claim 17, wherein determining the one or more resources comprises:
determining the one or more resources based on a set of resources allocated for a SDT random access procedure.

22. The method of claim 17, wherein determining the one or more resources comprises:
in accordance with a determination that uplink data associated with the mobile terminated type SDT procedure is to be transmitted in a random access procedure message, determining the one or more resources based on a set of resources allocated for a SDT random access procedure.

23. The method of claim 17, wherein determining the one or more resources comprises:
receiving, from the second device, an indication of the one or more resources used for the mobile terminated type SDT procedure; and
determining the one or more resources based on the indication.

24. (canceled)

25. The method of claim 17, wherein determining the one or more resources comprises:
obtaining a set of random access resources specified for the mobile terminated type SDT procedure; and
in accordance with a determination that at least one criteria for initiating the mobile terminated type SDT procedure is satisfied while at least one criteria for initiating a mobile originated type SDT procedure fails to be satisfied, determining the one or more resources based on the set of random access resources specified for the mobile terminated type SDT procedure.

26. The method of claim 17, wherein determining the one or more resources comprises:
obtaining a set of random access resources specified for the mobile terminated type SDT procedure; and
in accordance with a determination that no uplink data is to be transmitted or uplink data to be transmitted having a data volume less than a threshold volume, determining the one or more resources based on the set of random access resources specified for the mobile terminated type SDT procedure.

27-34. (canceled)
